(19) United States
(12) Patent Application Publication
(10) Pub. No.: US 2025/0037262 A1
(43) Pub. Date: Jan. 30, 2025

(54) METHOD FOR DETERMINING A POSITION OF ELECTRODE SHEETS IN AN ELECTRODE/SEPARATOR ASSEMBLY

(71) Applicant: Volkswagen Aktiengesellschaft, Wolfsburg (DE)

(72) Inventor: Steffen MASUCH, Braunschweig (DE)

(73) Assignee: Volkswagen Aktiengesellschaft, Wolfsburg (DE)

(21) Appl. No.: 18/784,913

(22) Filed: Jul. 26, 2024

(30) Foreign Application Priority Data
Jul. 26, 2023 (DE) 10 2023 207 152.5

(51) Int. Cl. G06T 7/00; G06T 7/13; G06T 7/60; G06T 7/73; H01M 10/04

(52) U.S. Cl. CPC G06T 7/0004; G06T 7/13; G06T 7/60; G06T 7/73; G06T 2200/04; G06T 2207/10081; G06T 2207/30108; H01M 10/0404

(57) ABSTRACT

A method for determining a position of electrode sheets in an electrode/separator assembly, the electrode sheets including a substrate and a bilateral coating of the substrate. The electrode sheets comprising at least one first and one second type of electrode sheets. Each electrode sheet is optically imaged, at least in regions, in one or multiple image regions. At least one region of a geometry of the substrate and at least one region of a geometry of the bilateral coating of the substrate is determined, based on the optical image. The electrode sheets are stacked to form an ESA. At least one of the two components of the electrode sheets of the first type is captured in the ESA and at least one of the two components of the electrode sheets of the second type in the ESA is captured in a computed-tomographic image.

This nonprovisional application claims priority under 35 U.S.C. § 119 (a) to German Patent Application No. 10 2023 207 152.5, which was filed in Germany on Jul. 26, 2023, and which is herein incorporated by reference.

### BACKGROUND OF THE INVENTION

### Field of the Invention

The invention relates to a method for determining a position of electrode sheets in an electrode/separator assembly as well as a system and a computer program for carrying out the method.

### Description of the Background Art

To manufacture cells, arrester contours must be cut into the continuous electrode foils. This is carried out with the aid of the so-called laser cutting process (notching).

A further cut then takes place at a right angle to the laser cut, so that an individual electrode sheet is present. Each electrode sheet includes a substrate as well as a coating on both sides of the substrate. In the case of the laser cut, it is customary to cut in an uncoated contacting region of the anode sheets or cathode sheets. This is due to a higher process speed as well as to the achievable cut edge properties or safety requirements. If a cut is made in the active region, i.e., in the region of the coatings, it is possible for burrs and weld spatter to occur. If the latter enter the cell during the further process, this may result in short-circuits due to the penetration of the separator or due to dendrite growth.

For these reasons, a preferred variant is to cut in the substrate of the anode and cathode and not in the active material. The uncoated region of the electrode sheets is referred to colloquially as the “naked shoulder.”

In the subsequent stacking process, the anode sheets, cathode sheets, and separators are alternately combined to form an electrode/separator assembly (ESA).

The placement accuracy of the electrode sheets in the ESA is the criterion for the quality of the process capability of the stacking machine and is a product feature of the ESA relevant for safety and functioning. All corner regions of the electrode sheets must have a defined distance from each other and be situated in a defined tolerance band. The electrochemical performance of a battery cell decreases more rapidly during operation with a smaller electrode overlay. A short-circuit and failure of the battery cell are also triggered by a direct contact of the anode and cathode in the case of an incorrect placement.

At present, the anode (minus) is slightly larger circumferentially than the cathode (plus) of a compartment to implement a complete overlay of the anode and cathode, despite placement inaccuracies.

Current efforts attempt to reduce the size of this anode overhang to save material.

This means that increasing requirements relating to placement accuracy are imposed on the stacking process. In addition, the stacking process is a bottleneck in battery cell manufacturing, so that its process speed must be increased in the future. However, the placement accuracy decreases as the process speed increases. To further optimize and develop stacking processes, the placement of the electrodes in the stack assembly must be measured.

The position of the electrode sheets in the ESA is determined with the aid of computed tomographic imaging methods. However, there is the disadvantage here that certain materials of the anode or cathode sheets (coating or substrate) do not provide any CT contrast and thus remain indiscernible in the CT image.

### SUMMARY OF THE INVENTION

It is therefore an object of the present invention to improve the capture and determination of the position, and thus the placement accuracy, process capability, and an overlay criterion, in such a way that the indiscernible components in the CT data of the electrode sheets may be taken into account in the evaluation.

A first aspect of the invention relates to a method for determining a position, in particular a 3D position, of electrode sheets in an electrode/separator assembly, ESA, the electrode sheets including at least two components, namely a substrate and a bilateral coating of the substrate, in particular in an active region of the electrode sheet, in particular the substrate of the electrode sheets being uncoated at least in a contacting region, the electrode sheets comprising at least a first and a second type of electrode sheet, namely, in particular, anode sheets as the first type and cathode sheets as the second type, which are manufactured from a different substrate and a different coating material, the method comprising the following steps: Optically imaging each electrode sheet at least in regions, in particular together with the uncoated contacting region of the substrate and the active region coated on both sides; Determining at least one region of a geometry of the substrate and at least one region of a geometry of the bilateral coating of the substrate for each electrode sheet, based on the optical image; Indexing each electrode sheet, so that an assignment of each electrode sheet and the geometries determined therefor may take place from the optical images and the type of electrode sheet in the ESA; Stacking the electrode sheets to form an ESA; Computed-tomographically (CT) capturing at least one of the two components of the electrode sheets of the first type in the ESA and at least one of the two components of the electrode sheets of the second type in the ESA in a computed-tomographic image; Determining a geometry of the particular captured component, at least in regions, based on the computed-tomographic image; Aligning and, in particular, scaling the particular geometries from the optical images with the geometries of the electrode sheets in the ESA determined from the computer-tomographic image, in particular so that a position of the geometries from both images coincides; and Ascertaining a position of the substrate of each electrode sheet and its bilateral coating, the position of non-captured components in the computed-tomographic image being determined from the aligned or the co-aligned geometries of the optical images, so that a position of all components of the electrode sheets of the ESA is determined in the ESA.

The invention makes it possible to easily and reliably supplement the information relating to the geometries of the substrate or its coating which is missing in the computed-tomographic (CT) data, so that important pieces of information are obtained for determining the process capability and/or product quality for each ESA.

The coating of the substrate is made up of at least one coating material, which may be different for the two types of electrode sheets.

The missing information in the CT data has to do with the materials used in the ESA, since some coating materials or substrate materials have no and only limited CT contrast. These layers therefore remain indiscernible in the CT images, so that the geometries of these indiscernible layers may not be incorporated into the determination of the process capability and product quality.

The invention now proposes to supplement these missing pieces of information, based on previously obtained optical data. For this purpose, it is necessary to completely capture each electrode sheet prior to stacking.

The electrode sheets are subsequently re-identified in the CT data, and the optically captured geometries may be assigned to the particular substrates and coatings.

The position of an electrode sheet, the substrate, and/or its coating, in particular a three-dimensional position assigned to the electrode sheet in the ESA as well as an orientation, is determined, in particular, in relation to an ESA imaging device, such as a frame.

In the context of the present specification, a geometry can be understood to be, for example, an outer contour, which encompasses a boundary of the particular element.

According to a further example, it is provided that, in the case of electrode sheets of the first type, the coating of the electrode sheet is not captured by means of computed tomography, and in the case of electrode sheets of the second type, the substrate is not captured by means of computed tomography.

The expression “not captured” in this connection can mean, for example, that a signal-to-noise ratio, SNR, is too low for an evaluable contrast to result in the CT data, based on which a geometry of the coating or the substrate would be sufficiently precisely ascertainable. The low SNR is due to the absorption capacity of the particular material, which may be only poorly absorbed or not at all within the wavelength range used in the CT image.

At least one material of the coating or the substrate in the ESA is typically “indiscernible,” i.e. not captured, in the CT data.

The process steps of the optical imaging, the processing thereof to determine the geometry, as well as the indication of the electrode sheets may also take place during the stacking of the electrode sheets to form the ESA, so that a particularly efficient processing is ensured here.

Each electrode sheet can have the bilateral coating in an active region, and the substrate of the electrode sheets is uncoated at least in a contacting region.

Each electrode sheet can extend in an x-y plane assigned to the electrode sheet, which is spanned by a x axis and a y axis of a Cartesian coordinate system and a z axis, which points along a stack direction of the ESA stack.

The contacting region of each electrode sheet can extend in a boundary region of the electrode sheet and thereon extends along a transitional edge adjacent to the active region of the electrode sheet, a position of the transitional edge being determined for each electrode sheet at least on the basis of the aligned geometries of the optical image. The position of the transitional edge may therefore by captured in the CT data; alternatively or additionally, it may be determined on the basis of the CT data.

These transitional edges are important for determining the process capability and product quality, since a degree of offset, relative rotation, and overlapping of the electrode sheets may be determined based on the transitional edges.

The contacting region can form an outer edge of the electrode sheet, a position of the outer edge being determined for each electrode sheet in the ESA at least on the basis of the aligned geometries of the optical image.

The contacting region is also referred to by those skilled in the art as the “naked shoulder.” The contacting region is typically situated at least in an outer region of the electrode sheet so that a connectability is ensured.

The determination of the outer edge therefore can correspond to an outer boundary of the electrode sheet in the region of the contacting region, i.e., the naked shoulder.

A position of a blunt edge of the electrode sheet in the ESA can be determined for each electrode sheet at least on the basis of the aligned geometries of the optical image, the blunt edge corresponding to an edge of the electrode sheet opposite the contacting region.

The blunt edge comprises, for example, an edge of the substrate as well as an edge of the bilateral coating, which ideally all have the same position. In some designs, however, a graduation along the one second transitional edge may also take place in the region of the blunt edge, so that the substrate protrudes slightly beyond the bilateral coating. Accordingly, this additional graduation must then also be taken into account to ascertain the overlay of the active region and the placement accuracy.

In particular, the position of each electrode sheet may be determined with great precision, based on the position of the transitional edge, the outer edge, and the blunt edge for each electrode sheet, so that the placement accuracy, and thus the process capability as well as the product quality, may be precisely determined.

An overlay criterion of the active regions of the electrode sheets can be determined, in particular, along the x-z plane, one or multiple of the following first offsets being determined with the aid of the ascertained position of the transitional edges of the electrode sheets and the ascertained positions of the blunt edges of the electrode sheets: a maximum offset, in particular along the x-y plane, in particular along the x direction and/or the y direction, of the position of the transitional edges of the electrode sheets of the first type; a maximum offset, in particular along the x-y plane, in particular along the x direction and/or the y direction, of the position of the transitional edges of the electrode sheets of the second type; a maximum offset, in particular along the x-y plane, in particular along the x direction and/or the y direction, of the position of the blunt edges of the electrode sheets of the first type; a maximum offset, in particular along the x-y plane, in particular along the x direction and/or the y direction, of the position of the blunt edges of the electrode sheets of the first type; a minimum offset, in particular along the x-y plane, in particular along the x direction and/or the y direction, of the position of the transitional edges of the electrode sheets of the first type with respect to the position of the blunt edges of the electrode sheets of the second type; and/or a minimum offset, in particular along the x-y plane, in particular along the x direction and/or the y direction, of the position of the transitional edges of the electrode sheets of the second type with respect to the position of the blunt edges of the electrode sheets of the first type.

The overlay criterion can be ascertained by a check of the extent to which the offsets are within predefined tolerance ranges. A process capability and/or a product quality may be ascertained based on these offsets. These offsets provide information about the position of the electrode sheets in the ESA along the x-y plane, so that a determination may be made for each electrode sheet as to whether it is within a tolerance range with its active region and/or whether the electrode sheet is within a tolerance range for the corners/boundaries for electrode sheets of the first or second type. The process capability and/or the product quality may be ascertained based on this determination.

The offset may be ascertained, for example, in the form of distances.

A placement accuracy of the electrode sheets can be ascertained, in particular, with respect to the x-z plane, one or multiple of the following second offsets being determined with the aid of the ascertained positions of the outer edges of the electrode sheets and the ascertained positions of the blunt edges of the electrode sheets: a maximum offset, in particular along the x-y plane, in particular along the x direction and/or the y direction, of the position of the outer edges of the electrode sheets of the first type; a maximum offset, in particular along the x-y plane, in particular along the x direction and/or the y direction, of the position of the outer edges of the electrode sheets of the second type; a maximum offset, in particular along the x-y plane, in particular along the x direction and/or the y direction, of the position of the blunt edges of the electrode sheets of the first type; a maximum offset, in particular along the x-y plane, in particular along the x direction and/or the y direction, of the position of the blunt edges of the electrode sheets of the second type; a minimum offset, in particular along the x-y plane, in particular along the x direction and/or the y direction, of the position of the outer edges of the electrode sheets of the first type with respect to the position of the blunt edges of the electrode sheets of the second type; and/or a minimum offset, in particular along the x-y plane, in particular along the x direction and/or the y direction, of the position of the outer edges of the electrode sheets of the second type with respect to the position of the blunt edges of the electrode sheets of the first type.

In particular, the placement accuracy can be ascertained from the aforementioned offsets, in particular by checking whether the offsets are within predefined tolerance ranges.

The maximum and minimum offsets can be ascertained with respect to the particular edge from the quantity of the offsets of all electrode sheets.

The position of the transitional edge can comprise a first position of the transitional edge for a first side of the bilateral coating and a second position of the transitional edge for a second side of the bilateral coating of the electrode sheet opposite the first side along the stack direction, the first and second positions of the transitional edge being determined at least on the basis of the aligned geometries of the optical image.

This permits a side-selective ascertainment of the transitional edge, and a deviation of the position of these edges may be taken into account in further evaluation steps.

The position of the transitional edge can be ascertained from a mean value of the first and second positions of the transitional edge, or the first or the second position of the transitional edge is assigned to the position of the transitional edge for the purpose of ascertaining the first offsets.

Each offset for each electrode sheet is determined for two opposite corner regions of the electrode sheet along the y axis, in particular two opposite corner regions thereof only along the y axis, a tolerance range being predefined for each of the offsets, it being ascertained for each corner and its ascertained and assigned offsets whether at least one of the ascertained and assigned offsets is situated outside the tolerance range assigned thereto, in particular a reject being assigned to the ESA if at least one of the offsets is situated outside the tolerance range assigned thereto.

It may be determined in this way, based on the ascertained offsets, whether the ESA may have to be scrapped if it does not meet certain quality criteria.

The transitional edge of at least one electrode sheet can run at an angle, in particular along the y axis, so that the first offsets are of different sizes for each of the two corner regions with respect to the position of the transitional edge running at an angle.

The position of the transitional edge of the electrode sheets can corresponds to a mean value made up of all positions of the transitional edge ascertained for the particular electrode sheet, so that the position remains robustly determinable with respect to chipping or a rough transitional edge profile.

This aspect makes it possible to determine an edge profile, which is robust against roughness and minor edge defects.

The position of the transitional edge of the electrodes of the first type can be determined only from the optical image.

The transitional edge may be determined thereby with particularly high accuracy, in particular since this edge is not or only poorly captured in the CT data and is thus impossible or difficult to detect.

The position of the outer edge of the electrode sheets of the second type can be determined only from the optical image.

The outer edge may be determined thereby with particularly high accuracy, in particular since this edge is not or only poorly captured in the CT data and is thus impossible or difficult to detect.

A system is also provided, which includes at least the following components for determining quality and process parameters of an ESA: an optical capture unit, which is configured to take optical images of electrode sheets from a first side and a second side of the electrode sheet; an ESA stacking device, which is configured to stack the electrode sheets to form a ESA, the system being configured to index each electrode sheet so that an assignment of each electrode sheet from the optical images takes place in the ESA; and/or a computer-tomographic imaging device, which is configured to generate a three-dimensional image of the ESA stack, characterized in that the system comprises a computer, which is configured to control the components of the system via interfaces and to carry out the method according to one of the preceding claims.

According to a further aspect of the invention, a computer program is provided, which comprises computer program code, which, when run on a computer, in particular when run on the computer of the system, prompts the computer to carry out the method according to the invention.

A computer program in the context of this specification can be understood to be, for example, also a computer program product, i.e., a computer program code stored on a non-transitory storage medium.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1A to 1D show an example of a system for carrying out the method according to the invention;

FIG. 2 shows an example of a sectional view along an x-z plane of a region of a CT image;

FIG. 3 shows a schematic representation of the electrode sheets of the first type;

FIG. 4 shows a schematic representation of the electrode sheets of the second type;

FIG. 5 shows a schematic representation of a sectional view of an ESA, including a determination of the offsets of the electrode sheets; and

FIG. 6 shows a schematic representation of the electrode sheets of the first type having different edge profiles.

### DETAILED DESCRIPTION

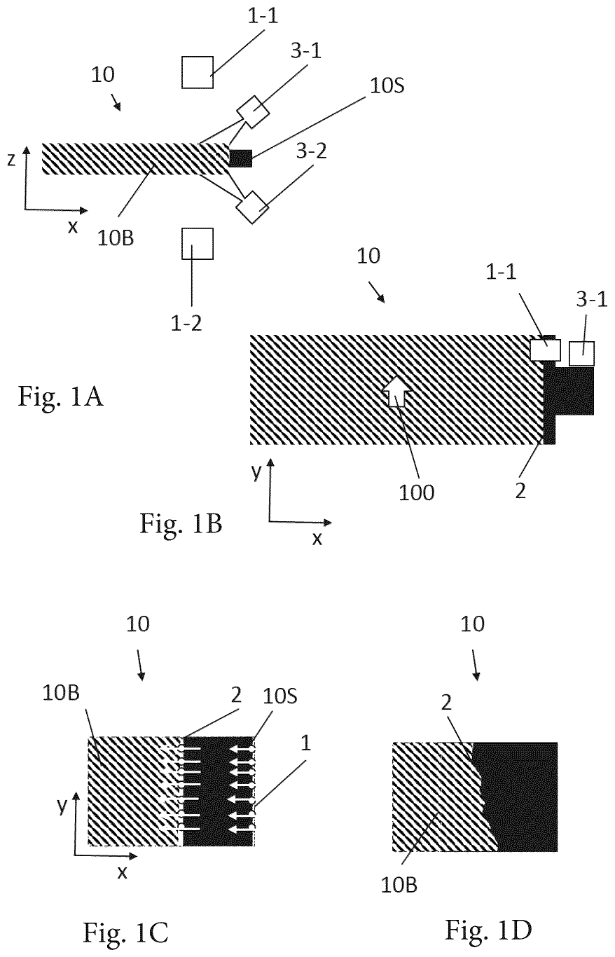

A side view of an electrode sheet 10, along with an optical capture unit of the system, is illustrated schematically in FIG. 1A. The optical capture unit comprises two line scan cameras 1-1, 1-2, which are offset along the z axis with respect to an assigned coordinate system and therefore each optically capture one side of an electrode sheet 10 to be imaged. Electrode sheet 10 extends along an x-y plane and is moved along the y direction (into or out of it in the image plane).

A light source 3-1, 3-2 is assigned to each camera, which illuminates electrode sheet 10 on one side in each case for the purpose of ensuring uniform imaging conditions.

Electrode sheet 10 comprises a substrate 10S, which extends along the x-y plane and is covered by a coating 10B on both sides over a wide area, which also extends along the x-y plane. Substrate 10S and bilateral coating 10B are manufactured from different materials.

During the movement of electrode sheet 10, line scan cameras 1-1, 1-2 capture, at least in one imaging region, the geometry of bilateral coating 10B as well as the visible, i.e. uncoated, portion of substrate 10S, which is also referred to as the naked or bare shoulder. In the context of the present specification, the coated portion of electrode sheet 10 is also referred to as the active region, while the uncoated portion of electrode sheet 10, which forms the bare shoulder, is referred to as the contacting region.

FIG. 1B shows a top view of the same scene as in FIG. 1A, in which a transitional edge 2 of electrode sheet 10 is apparent, which extends along the y axis. Transitional edge 2 is the edge that occurs on the boundary of coating 10B toward the active region. Line scan cameras 1-1, 1-2 capture at least this region but, in particular, also a multiplicity of other regions while electrode sheet 10 is being moved along the y axis.

An ascertained optical image of the region of transitional edge 2 captured by a line scan camera is illustrated in FIG. 1C. Transitional edge 2, as well as an outer edge 1 of substrate 10S, is captured in a multiplicity of locations along the y direction. Based on the locations, an edge profile is ascertained, for example by linear interpolation. In this way, an edge profile of transitional edge 2 and outer edge 1 may be ascertained for both sides of electrode sheet 10, the edge profile of outer edge 1 being identical for both sides. An essential portion of the geometry of electrode sheet 10 may be captured by the images.

FIG. 1D shows an edge profile of transitional edge 2, which has an increased roughness. For this reason, the capture of transitional edge 2 in a multiplicity of locations along the y axis is advantageous, since an improved ascertainment of the profile or an interpolated profile of transitional edge 2 may take place in this way.

In addition, an optical measurement of the complete electrode sheet geometry may take place in parallel, for example by ascertaining a length (in the x direction) and a width (in the y direction).

This may take place with the aid of a further camera arrangement, which is not illustrated, together with light sources, and which also comprises, for example, two correspondingly arranged line scan cameras. In particular, a blunt edge of electrode sheet 10 may thus be captured along the x axis opposite the contacting region. This makes it possible to capture geometries of the electrode sheets which are arranged in a manner rotated 180° in the x-y plane.

Due to the bilateral ascertainment of transitional edges 2, offsets of the two coatings on an electrode sheet 10 may possibly likewise be established, which may be taken into account in further evaluations.

The optically captured regions of electrode sheets 10 permit a geometry of electrode sheet 10 to be ascertained, based on the optical images, at least where the relevant edge profiles are concerned.

Imaged electrode sheets 10 are then combined into an ESA stack, which is stacked essentially along the z direction. ESA 4 comprises electrode sheets 10 of a first and a second type. These are typically electrode sheets which form the anodes, i.e., anode sheets, and electrode sheets which form the cathodes, i.e., cathode sheets.

To be able to assign electrode sheets 10 to the optical images in the stack later on, electrode sheets 10 are indexed in such a way that a stack position may be established, for example with the aid of a number, based on the indexing.

The ESA stack is captured three-dimensionally, at least in regions, with the aid of a computer tomographic imaging device.

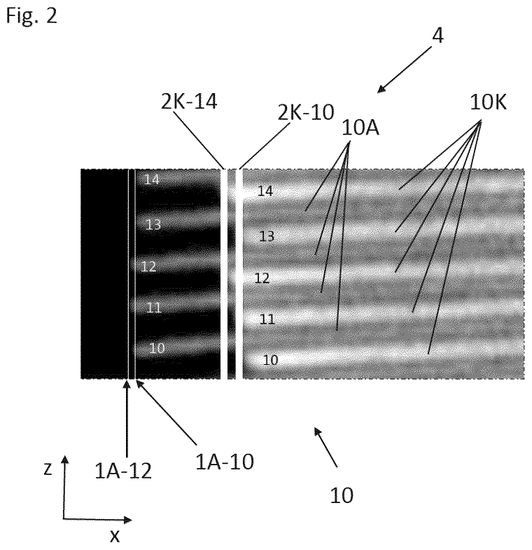

FIG. 2 shows a CT image for a region of an ESA 4 stack in a sectional view along an x-z plane. The outer edge regions of anode sheets 10A (numbered from 14 to 10) and their maximum offset along the x direction, based on ascertained outer edges 1A-10, 1A-12 of electrode sheets 10, are illustrated. A maximum offset along the x direction for the transitional edges of cathode sheets 10K (also numbered from 14 to 10) is likewise illustrated.

The offsets are then compared with a tolerance range, which indicates the tolerances for offsets of the position of the electrode sheets. If the offsets are within the tolerance ranges, ESA 4 meets the predefined quality criteria. If this is not the case, ESA 4 may possibly be assigned to a reject.

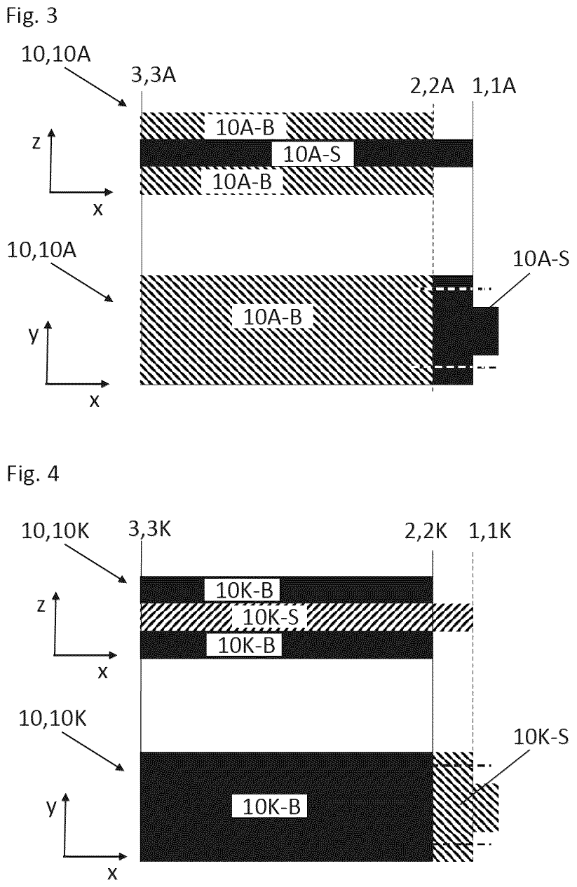

Electrode sheets of the first or second type 10A, 10K are each illustrated in FIGS. 3 and 4. FIG. 3 shows examples of two schematic sectional views of an anode sheet 10A, a blunt edge 3, 3A, a transitional edge 2, 2A, and an outer edge 1, 1A of anode sheet 10A also being illustrated. Anode sheet 10A comprises a bilateral coating 10A-B and a substrate 10A-S. The material of coating 10A-B, e.g., graphite, is not captured in the CT images and is therefore indiscernible or difficult to detect in a CT image of an ESA. The material of substrate 10A-S, e.g. copper, on the other hand, offers a sufficiently high CT contrast, so that the substrate is visible in a CT image of the ESA.

Examples of two schematic sectional views of a cathode sheet 10K are similarly illustrated in FIG. 4. The cathode sheet comprises a bilateral coating 10K-B and a substrate 10K-S, a blunt edge 3, 3K, a transitional edge 2, 2K, and an outer edge 1, 1K of cathode sheet 10K again being indicated here. The material of substrate 10K-S, e.g., aluminum, is not captured in the CT images and is therefore indiscernible or difficult to detect in a CT image of an ESA. The material of coating 10K-B, e.g. lithium, on the other hand, offers a sufficiently high CT contrast, so that bilateral coating 10K-B is visible in a CT image of the ESA.

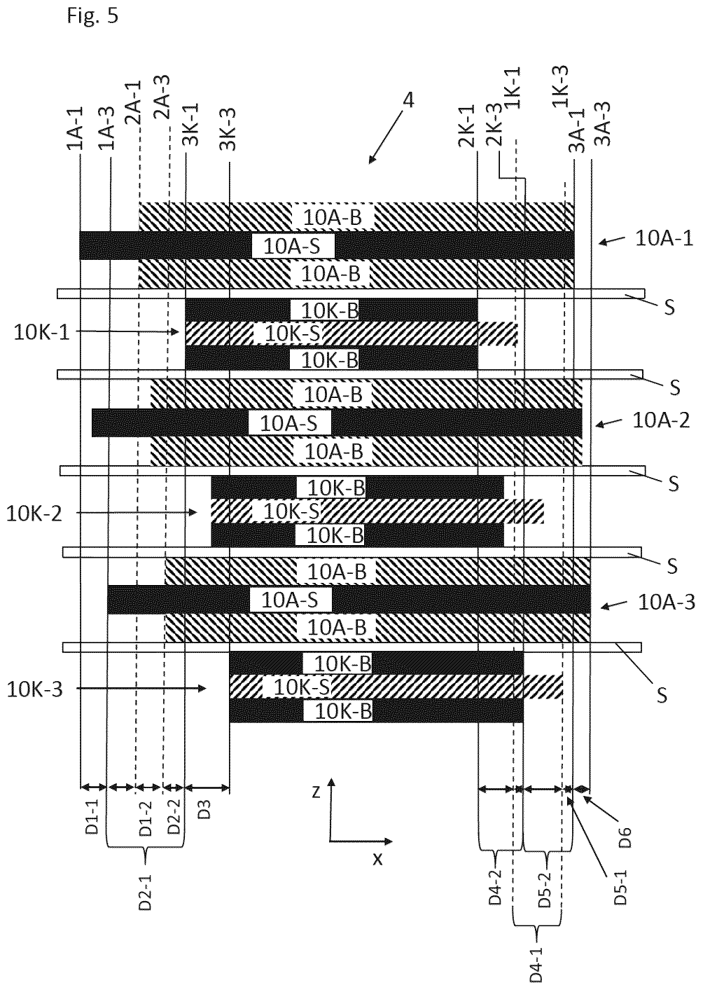

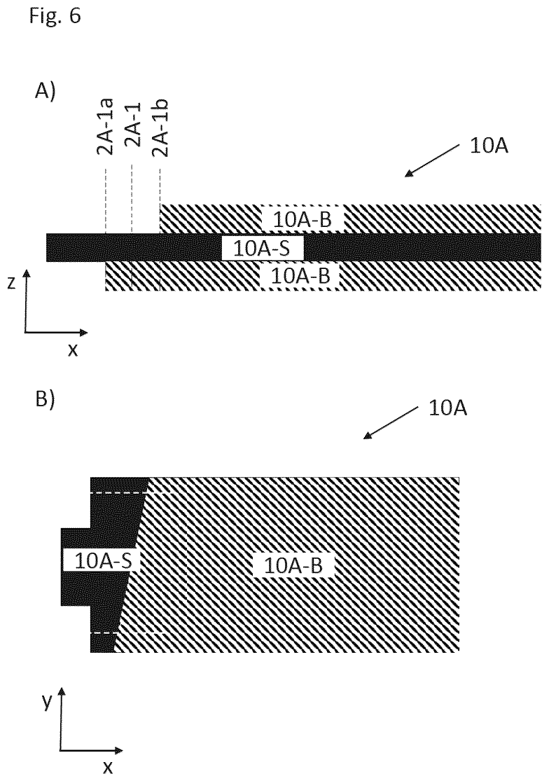

A schematic sectional view of an ESA 4 along the x-z plane is illustrated in FIG. 5. In this case, ESA 4 comprises only three anode sheets and three cathode sheets 10A-1, 10A-2, 10A-3, 10K-1, 10K-2, 10K-3 to avoid making the illustration unnecessarily complex.

As is further illustrated in FIG. 5, anode sheets 10A-1, 10A-2, 10A-3 and cathode sheets 10K-1, 10K-2, 10K-3 are stacked so as to be rotated 180° with respect to each other in the x-y plane, so that outer edges 1A-1, 1A-3, 1K-1, 1K-3 point in opposite x directions. Separator layers S are also arranged between the electrode sheets in ESA 4.

Since the substrate of the cathode sheets and the coating of the anode sheets are indiscernible in the CT image, as described with respect to FIGS. 3 and 4, selected edges or geometries of the electrode sheets may be ascertained or assigned only based on the optical data.

The nomenclature of the edges in this example takes place according to the following logic:

The first digit determines the edge, i.e., in particular, the outer edge (1), the transitional edge (2), and the blunt edge (3).

The following letter determines the type of electrode sheet, anode (A) or cathode (K) in this case. The last digit indicates the position in the ESA. The higher the electrode sheet is arranged, the lower the number.

Thus, “2A-3” designates the transitional edge of the anode sheet which is arranged at the very bottom of all anode sheets in the illustrated ESA. “1K-1” refers to the outer edge of the topmost cathode sheet.

As is apparent from FIG. 5, transitional edges 2A-1, 2A-3 of anode sheets 1A-1, 1A-3 as well as outer edges 1K-1, 1K-3 of the cathode sheets may be ascertained only based on the assigned optical data.

For this purpose, the geometries of the optical images are aligned with the geometries of the electrode sheets in ESA 4 determined from the computer-tomographic image and scaled, if necessary. Since at least one geometry—that of the substrate or that of the coating in the CT image—is visible for each electrode sheet, a transformation may be ascertained for each electrode sheet, based on which the geometries ascertained from the optical images may be correlated with the geometries ascertained from the CT data, the corresponding transformation for the electrode sheet being used for the geometries captured only in the optical images, so that a very good ascertainment of the geometry and position of all substrates and coatings may be assumed.

To now ascertain different quality criteria of the ESA, in particular, offsets of different edges of the electrode sheets relative to each other in the x-y plane are relevant, in particular along the x direction.

A rotation relative to a stack axis or the other electrode sheets may likewise be ascertained.

For example, to determine the quality criterion of process capability, the following distances or offsets are ascertained:
D1-1: A maximum offset of outer edge 1A-1, 1A-3 of anode sheets 10A-1, 10A-3 with respect to each other;
D2-1: A minimum offset of outer edge 1A-3 of anode sheets 10A-3 with respect to blunt edge 3K-1 of cathode sheets 10K-1, i.e., the smallest offset of all offsets of outer edges of the anode sheets with respect to the blunt edges of the cathode sheets;
D3: A maximum offset of blunt edges 3K-1, 3K-3 of the cathode sheets with respect to each other;
D4-1: A maximum offset of outer edges 1K-1, 1K-3 of the cathode sheets;
D5-1: A minimum offset of outer edge 1K-3 of cathode sheets 10K-3 with respect to blunt edge 3A-1 of anode sheets 10A-1;
D6: A maximum offset of blunt edges 3A-1, 3A-3 of anode sheets 10A-1, 10A-3 with respect to each other.

Outer edges 1K-1, 1K-3 of cathode sheets 10K-1, 10K-3 may be determined only from the optical images. As a result, the method according to the invention permits a determination of offsets D4-1 and D5-1 and thus a determination of the quality criterion of process capability, despite the lack of information about these edge lengths from the CT data.

Based on the offsets determined in this way, a position may be ascertained, i.e., in particular, a piece of information about a position and orientation of each electrode sheet 10 in ESV 4. The offsets discussed above for ascertaining the process capability are advantageously ascertained at least for each corner region of electrode sheets 10, i.e., each edge is determined in at least two, in particular outer, locations (along the y axis) of electrode sheet 10 situated in the boundary region. Each of the offsets discussed above for ascertaining the process capability is assigned an, in particular predefined, tolerance range, within which the particular offset is to be situated, for each corner region. The process capability provides information, in particular, about the extent to which the outer regions of electrode sheets 10 are arranged regularly and precisely in ESA 4.

In addition to the process capability, a quality criterion in the form of an overlay criterion may also be determined, which provides information about an overlay surface area of the active regions of electrode sheets 10.

The overlay surface area corresponds, in particular, to the intersection of all active regions of the electrode sheets projected onto an x-y plane.

To determine the overlay criterion, in particular, the following offsets are ascertained from the geometries of the electrode sheets:
D1-2: A maximum offset of transitional edges 2A-1, 2A-3 of anode sheets 10A-1, 10A-3 with respect to each other.
D2-2: A minimum offset of transitional edge 2A-3 of anode sheets 10A-3 with respect to blunt edge 3K-1 of cathode sheets 10K-1, i.e., the smallest offset of all offsets of transitional edges of the anode sheets with respect to the blunt edges of the cathode sheets;
D3: A maximum offset of blunt edges 3K-1, 3K-3 of the cathode sheets with respect to each other;
D4-2: A maximum offset of transitional edges 2K-1, 2K-3 of the cathode sheets;
D5-2: A minimum offset of transitional edge 2K-3 of cathode sheets 10K-3 with respect to blunt edge 3A-1 of anode sheets 10A-1;
D6: A maximum offset of the blunt edges of the cathode sheets with respect to each other.

Transitional edges 2A-1, 2A-3 of the anode sheets may be determined only from the optical images. As a result, the method according to the invention permits a determination of offsets D1-2 and D2-2 and thus a determination of the overlay criterion, despite the lack of information about these edge lengths from the CT data.

Based on the offsets determined in this way, a position may be ascertained, i.e., in particular, a piece of information about a position and orientation of each electrode sheet in ESV 4.

The offsets discussed above for ascertaining the overlay criterion are advantageously ascertained at least for each corner region of the electrode sheets, i.e., each edge discussed above is determined in at least two, in particular outer, locations (along the y axis) of the electrode sheet situated in the boundary region. Each of the offsets discussed above for ascertaining the overlay criterion is assigned an, in particular predefined, tolerance range (which differs from the tolerance range of the placement accuracy/process capability), within which the particular offset is to be situated, for each corner region.

The ascertainment in at least two corner regions makes it possible to also take into account edge profiles running at an angle with respect to the y axis, cf. FIG. 6B.

The further use of the ESA may depend on whether the overlay criterion has been met, i.e., all offsets in all corner regions are within the provided tolerance ranges.

The following different situations may be taken into account with regard to the transitional edge of an electrode sheet.

Since the bilateral coating on both sides of the substrate may be captured by the imaging device, a transitional edge 2A-1a, 2A-1b may be ascertained for each side. To assign a transitional edge to the electrode sheet, for example, a mean value 2A-1, i.e. an average profile of the edge, from the two transitional edges may be used for further processing, cf. FIG. 6.A.

Alternatively, both edges are taken into account in the further processing steps of the method, so that, for example, the smaller overlay surface areas of two resulting active region overlay surface areas is used to determine the quality criterion.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining a position of electrode sheets in an electrode/separator assembly (ESA), the electrode sheets including at least two components, namely a substrate and a bilateral coating of the substrate, the electrode sheets comprising at least one first and one second type of electrode sheets, the method comprising:
optically imaging each electrode sheet, at least in regions, in one or multiple image regions;
determining at least one region of a geometry of the substrate and at least one region of a geometry of the bilateral coating of the substrate based on the optical image;
indexing each electrode sheet so that an assignment of each electrode sheet and the geometries determined therefor from the optical images in the ESA take place;
stacking the electrode sheets to form an ESA;
computed-tomographically capturing at least one of the two components of the electrode sheets of the first type in the ESA and at least one of the two components of the electrode sheets of the second type in the ESA in a computed-tomographic image;
determining a geometry of the particular captured component, at least in regions, based on the computed-tomographic image;
aligning the particular geometries from the optical images with the geometries of the electrode sheets in the ESA determined from the computer-tomographic image; and
determining a position of the substrate of each electrode sheet and its bilateral coating, the position of non-captured components in the computed-tomographic image being determined from the aligned geometries of the optical image, so that a position of all components of the electrode sheets of the ESA is determined in the ESA.

2. The method according to claim 1, wherein, in the case of electrode sheets of the first type, the coating of the electrode sheet is not captured by computed tomography, and in the case of electrode sheets of the second type, the substrate is not captured by computed tomography.

3. The method according to claim 1, wherein each electrode sheet has the bilateral coating in an active region, and the substrate of the electrode sheets being uncoated at least in a contacting region.

4. The method according to claim 3, wherein the contacting region of each electrode sheet extends in a boundary region of the electrode sheet and extends thereon along a transitional edge adjacent to the active region of the electrode sheet, a position of the transitional edge being determined for each electrode sheet at least on the basis of the aligned geometries of the optical image.

5. The method according to claim 3, wherein the contacting region forms an outer edge of the electrode sheet, a position of the outer edge being determined for each electrode sheet in the ESA at least on the basis of the aligned geometries of the optical image.

6. The method according to claim 1, wherein a position of a blunt edge of the electrode sheet in the ESA is determined for each electrode sheet, at least on the basis of the aligned geometries of the optical image, the blunt edge corresponding to an edge of the electrode sheet opposite the contacting region.

7. The method according to claim 4, wherein an overlay criterion of the active regions of the electrode sheets is ascertained, one or multiple of the following first offsets being determined for this purpose with the aid of the ascertained position of the transitional edges of the electrode sheets and the ascertained positions of the blunt edges of the electrode sheets:
a maximum offset of the position of the transitional edges of the electrode sheets of the first type;
a maximum offset of the position of the transitional edges of the electrode sheets of the second type;
a maximum offset of the position of the blunt edges of the electrode sheets of the first type;
a maximum offset of the position of the blunt edges of the electrode sheets of the second type;
a minimum offset of the position of the transitional edges of the electrode sheets of the first type with respect to the position of the blunt edges of the electrode sheets of the second type;
a minimum offset of the position of the transitional edges of the electrode sheets of the second type with respect to the position of the blunt edges of the electrode sheets of the first type.

8. The method according to claim 5, wherein a placement accuracy of the electrode sheets is ascertained, one or multiple of the following second offsets being determined for this purpose with the aid of the ascertained positions of the outer edges of the electrode sheets and the ascertained positions of the blunt edges of the electrode sheets:
a maximum offset of the position of the outer edges of the electrode sheets of the first type;
a maximum offset of the position of the outer edges of the electrode sheets of the second type;
a maximum offset of the position of the blunt edges of the electrode sheets of the first type;
a maximum offset of the position of the blunt edges of the electrode sheets of the second type;
a minimum offset of the position of the outer edges of the electrode sheets of the first type with respect to the position of the blunt edges of the electrode sheets of the second type;
a minimum offset of the position of the outer edges of the electrode sheets of the second type with respect to the position of the blunt edges of the electrode sheets of the first type.

9. The method according to claim 1, wherein the position of the transitional edge comprises a position of the transitional edge for a first side of the bilateral coating and a second position of the transitional edge for a second side of the bilateral coating of the electrode sheet, the first and the second position of the transitional edge being determined at least on the basis of the aligned geometries of the optical image.

10. The method according to claim 8, wherein each offset for each electrode sheet is determined for two opposite corner regions of the electrode sheet along the y axis, a tolerance range being predefined for each of the offsets, it being determined for each corner and its ascertained and assigned offsets whether at least one of the ascertained and assigned offsets is outside the tolerance range assigned thereto, a reject being assigned to the ESA if at least one of the offsets is outside the tolerance range assigned thereto.

11. The method according to claim 7, wherein the transitional edge of at least one electrode sheet runs at an angle along the y axis, so that the first offsets are of different sizes for each of the two corner regions with respect to the position of the transitional edge running at an angle and are determined and evaluated separately.

12. The method according to claim 1, wherein the position of the transitional edge of the electrode sheets of the first type is determined only from the optical image, and/or wherein the position of the outer edge of the electrode sheets of the second type is determined only from the optical image.

13. A system for determining quality and process parameters of an ESA, the system comprising:
an optical capture unit configured to take optical images of electrode sheets from a first side and a second side of the electrode sheet;
an ESA stacking device configured to stack the electrode sheets to form an ESA, the system being configured to index each electrode sheet so that an assignment of each electrode sheet from the optical images in the ESA takes place;
a computer-tomographic imaging device configured to generate a three-dimensional image of the ESA stack; and
a computer configured to control the components of the system via interfaces and to carry out the method according to claim 1.

14. A computer program comprising computer program code, which, when run on computer according to claim 13 prompts the computer to carry out the method.
